(19) United States
(12) Patent Application Publication
(10) Pub. No.: US 2016/0031049 A1
(43) Pub. Date: Feb. 4, 2016

(54) METHOD FOR NEW PRODUCTION OF A DIFFUSER IN A LASER SYSTEM

(71) Applicant: SIEMENS AKTIENGESELLSCHAFT, München (DE)

(72) Inventors: Christian MENKE, Essen (DE); Silke SETTEGAST, Berlin (DE); Volker VOSBERG, Müheim an der Ruhr (DE)

(21) Appl. No.: 14/772,561

(22) PCT Filed: Feb. 4, 2014
(86) PCT No.: PCT/EP2014/052133

§ 371 Date: Sep. 3, 2015

(30) Foreign Application Priority Data
Mar. 6, 2013 (EP) 13157912.0

(51) Int. Cl. B23P 15/02

(52) U.S. Cl. CPC B23P 15/02

(57) ABSTRACT

By previous inclusion of a through-hole in a substrate before coating and subsequent removal, the processing times for producing a through-hole with a diffuser are shortened and thereby the intermediate layers are less stressed.

### CROSS-REFERENCE TO RELATED APPLICATIONS

The present application is a 35 U.S.C. §§371 national phase conversion of PCT/EP2014/052133, filed Feb. 4, 2014, which claims priority of European Patent Application No. 13157912.0, filed Mar. 6, 2013, the contents of which are incorporated by reference herein. The PCT International Application was published in the German language.

### TECHNICAL FIELD

The invention relates to the production of a diffuser in a layer system.

### TECHNICAL BACKGROUND

Components, such as first- and second-row turbine blades are used in very high temperatures. They are provided, for the purpose of their protection from oxidation/corrosion and heat, with metallic and/or thermal layers.

Turbine blades, in particular have additional cooling air holes, through which cooling air flows.

On their surface on the outermost layer, these cooling air holes have a diffuser to produce a protective layer of air that lies over the surface of the turbine blade. The diffuser extends through the layers into the substrate. Since the diffuser represents a widening of the cylindrical lower portion of an air hole, a lot of material must be removed when the diffuser is created or reconstructed.

### SUMMARY OF THE INVENTION

The invention thus has the object of providing a method by means of which this can be carried out in an improved manner.

By previous inclusion of a through-hole in a substrate before coating and subsequent removal, the processing times for producing a through-hole with a diffuser are shortened and thereby the intermediate layers are less stressed.

By virtue of the method herein disclosed, such diffusers can be produced more quickly and also the intermediate layer bonding between the layers and/or with the substrate is subjected to substantially less stress.

### BRIEF DESCRIPTION OF THE DRAWINGS

In the figures:

FIGS. 1-5 show a method from the prior art for forming a diffusion in a substrate coated with layers,

FIGS. 6-10 show a method according to the invention,

FIG. 11 shows a list of superalloys and

FIG. 12 shows a turbine blade.

### DESCRIPTION OF PRIOR ART AND OF AN EMBODIMENT

The figures and the description represent only exemplary embodiments of the invention.

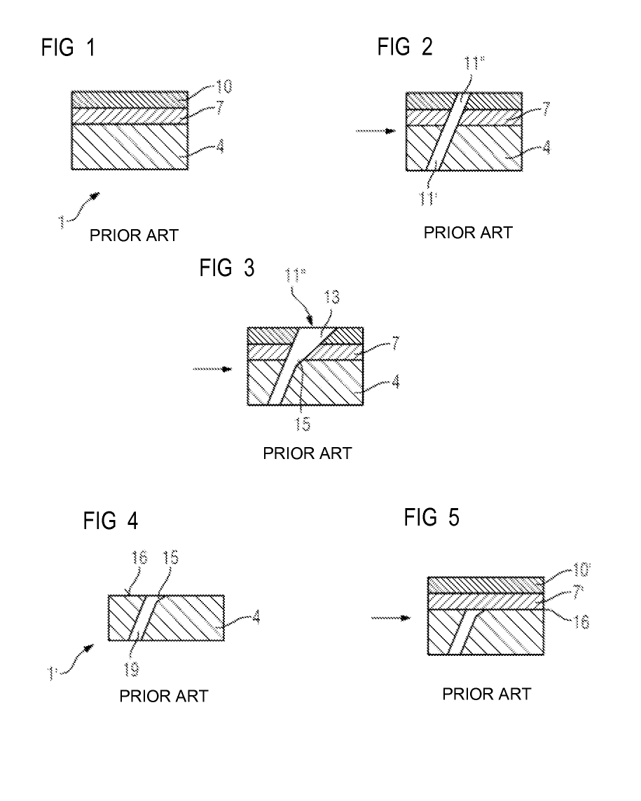

FIG. 1 shows a layer system 1 and FIGS. 2-5 show a production method according to the prior art. The system has a substrate 4, which includes thereon at least an inner layer 7 and an outermost layer 10. Other layer arrangements are known to the art.

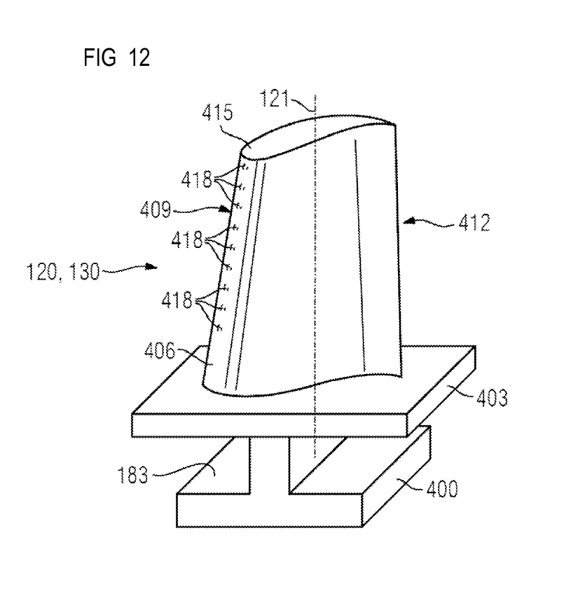

For turbine blades 120, 130 (FIG. 12), this system includes a metallic substrate 4, a metallic adhesion promoting layer (MCrAlX) with an optionally present aluminum oxide layer thereon and an outermost ceramic layer 10.

To produce a diffuser 13 (FIG. 3), first a cylindrical hole 11′, 11″ is created through the layers 7, 10 and through the substrate 4 (FIG. 2).

The cross section of the hole 11′, 11″ is at least constant over the entire length, as seen over the depth, after the first production step. It can also be of another shape.

An upper part 11″ of the through hole 11′, 11″ is widened in the region of the layers 7, 10 and of the substrate 4, (FIG. 3), which produces a diffuser 13. The diffuser 13 also has a diffuser portion 15 in the substrate 4.

FIG. 4 shows a component 1′ post-use and once layers on the substrate have been removed.

A turbine blade 120, 130 (FIG. 12) produced according to FIG. 1 can, according to the prior art, be re-used after prior use. In that case, the layers 7, 10 are removed (FIG. 4), the substrate 4 is inspected and if necessary re-worked, and then new layers 7, 10 are applied (FIG. 5).

The substrate 4 thus already has the diffuser portion 15 of the through hole 10 on its surface 16 (FIG. 4), which originates from the initial production of the diffuser 13 (FIG. 3).

Then layers 7′, 10′ (FIG. 5) are applied which also deposit in the region of the diffuser (here in the region 15). The overspray is then removed, or suitable measures are used to protect the hole 19 by stopping it. These measures are removed after coating, and the diffuser 13 is accordingly formed according to its final shape.

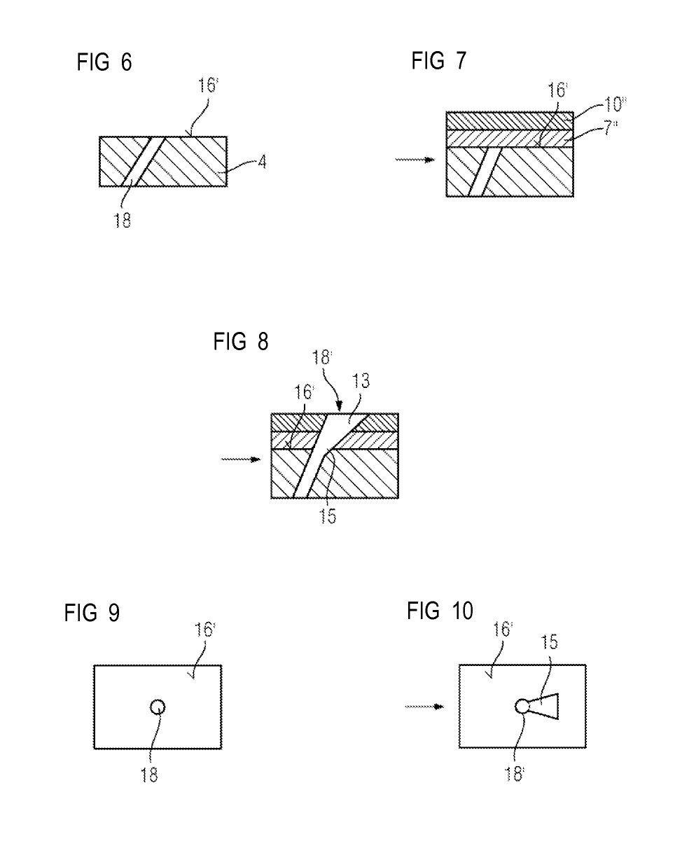

A method according to the invention for the new production of a through hole 18′ with a diffuser 13 is shown in FIGS. 6-10.

A through hole 18 is produced in the substrate 4 (FIG. 6). The hole 18 is in particular rotationally symmetric or has a constant cross section as seen over its depth. This can be created by EDM or laser machining.

However, this substrate 4 has no widening in the region of its surface 16′, as in the refurbished component 1′, as shown in FIG. 2.

Then layers 7″ (metallic, most preferably MCrAlX) and 10″ (ceramic) are applied (FIG. 7). The material of the applied layers 7″, 10″ enters into the hole 18.

Thereafter, the diffuser 13 is created through these layers 7″, 10″ (FIG. 8)and for the first time a diffuser portion 15 of the diffuser 13 is also created in the substrate 4, by the material of the substrate 4 being removed for the diffuser 13 (FIG. 8). This is performed preferably by laser machining.

A view onto the surface 16′ is shown in FIG. 9 is the original profile (as shown on the far left of FIG. 3) of the through hole 18 on the surface 16′ before widening (on the right of FIG. 4) for producing the diffuser 13.

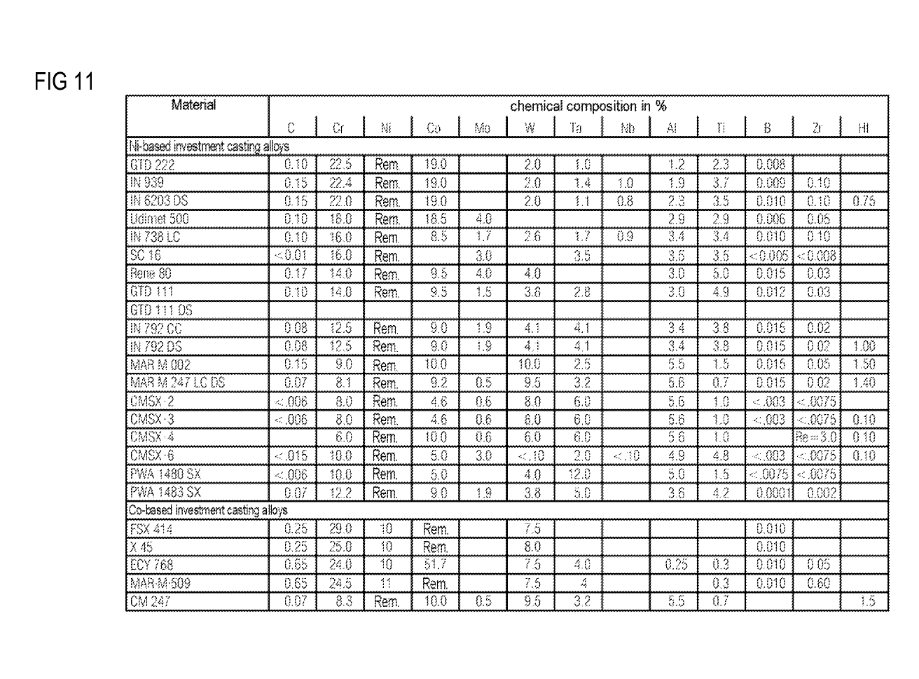

Such a component 1, 120, 130 preferably has a nickel- or cobalt-based superalloy, in particular as shown in FIG. 11, and preferably represents a turbine blade as shown in FIG. 12.

1. A method for producing a through hole in a layer system comprised of a metallic substrate and at least one layer with an outer diffuser, through the at least one layer, the method comprising:
introducing a through hole into the substrate and extending through the thickness of the substrate; and
then coating the substrate with at least one of an inner metallic layer and an outer ceramic layer, then introducing in a machining step, a diffuser into the at least one layer and into the substrate;
machining the diffuser comprising removing additional material in a diffuser portion of the substrate for causing the diffuser portion to comprise a widening of the through hole at a surface of the substrate that is beneath the at least one layer on the substrate and wherein the diffuser represents an asymmetric widening of the upper part of the through hole.

2. The method as claimed in claim 1, further comprising machining the metallic substrate.

3. The method as claimed in claim 1, wherein at least one of the layers is a ceramic layer.

4. The method as claimed in claim 1, further comprising using a laser removal method for the removing of additional material in a diffuser portion of the substrate.

5. The method as claimed in claim 4, further comprising:
producing the through hole using pulse durations in a millisecond range.

6. The method as claimed in claim 4, further comprising using pulse durations in the nanosecond range or the sub-nanosecond range, to create the diffuser or at least to remove the ceramic layers and the portion.

7. The method as claimed in claim 1, wherein the introduced through hole has a constant cross-section.

8. The method as claimed in claim 4, wherein the removal method uses substantially different pulse frequencies.

9. The method as claimed in claim 5, wherein the pulse durations are greater than or equal to 1 ms.

10. The method as claimed in claim 6, wherein the pulse durations are less than or equal to 800 ns.

11. The method as claimed in claim 6, wherein the pulse durations are less than or equal to 600 ns.
